(19) United States
(12) Patent Application Publication
(10) Pub. No.: US 2013/0325515 A1
(43) Pub. Date: Dec. 5, 2013

(54) CLINICAL DECISION SUPPORT SYSTEM FOR PREDICTIVE DISCHARGE PLANNING

(71) Applicants: Mariana Nikolova-Simons, Bolton, MA (US); Johan Muskens, Hurwemem (NL); Joseph Ernest Rock, Littleton, MA (US); Hans-Aloys Wischmann, Henstedt-Ulzburg (DE)

(72) Inventors: Mariana Nikolova-Simons, Bolton, MA (US); Johan Muskens, Hurwemem (NL); Joseph Ernest Rock, Littleton, MA (US); Hans-Aloys Wischmann, Henstedt-Ulzburg (DE)

(73) Assignee: KONINKLIJKE PHILIPS N.V., EINDHOVEN (NL)

(21) Appl. No.: 13/983,643

(22) PCT Filed: Feb. 1, 2012
(86) PCT No.: PCT/IB12/50474

§ 371 Date: Aug. 5, 2013

Related U.S. Application Data
(60) Provisional application No. 61/439,586, filed on Feb. 4, 2011.

(51) Int. Cl. G06F 19/00; G06Q 50/24

(52) U.S. Cl. CPC G06F 19/3431; G06Q 50/24
USPC 705/3

(57) ABSTRACT

A system and method for patient discharge planning. The system and method include evaluating a patient record including patient data parameters of a patient, predicting a change in the patient record for all possible treatment options, generating a discharge recommendation based on at least one of the patient record and the predicted change in the patient record and displaying the discharge recommendation to a user.

### BACKGROUND

Discharge planning is a difficult process for physicians and hospital professionals. Discharge planning may be especially complicated for patients suffering from certain diseases and/or conditions. For example, managing a patient suffering from acute decompensated heart failure (ADHF) can be complex because of the different etiology and many co-morbidities such as renal dysfunction, COPD, hypertension, diabetes, sleep apnea, etc. Discharge planning is further complicated by the fact that there is currently no objective measurement for determining whether a patient is ready to be discharged from the hospital. A patient that is discharged too early may experience inadequate symptom relief and may require readmission to the hospital, resulting in increased costs. Unmet patient needs are not systematically identified prior to a discharge decisions and are thus not proactively addressed. In addition, current discharge planning tools cannot predict a patient's readiness for discharge based on a particular treatment or treatment modification. Thus, it is impossible to estimate factors such as a patient's currently projected length of stay and the potential for a reduction, risk for readmission and total medical costs, which makes it difficult for the hospital to prepare and plan accordingly.

### SUMMARY OF THE INVENTION

A method of patient discharge planning including evaluating a patient record including patient data parameters of a patient, predicting a change in the patient record for all possible treatment options, generating a discharge recommendation based on at least one of the patient record and the predicted change in the patient record; and displaying the discharge recommendation to a user.

A system for discharge planning having a memory storing a patient record including patient data parameters for a patient and a population database including patient data for all patients. The system further includes a processor evaluating the patient record, predicting a change in the patient record and generating a discharge recommendation based on at least one of the patient record and the predicted change in the patient record and a display displaying the discharge recommendation.

A non-transitory computer-readable storage medium including a set of instructions executable by a processor. The set of instructions operable to evaluate a patient record including patient data parameters of a patient, predict a change in the patient record for all possible treatment options, generate a discharge recommendation indicating whether the patient is ready for discharge with respect to the patient record and display the discharge recommendation to a user.

### BRIEF DESCRIPTION OF THE DRAWINGS

FIG. 1 shows a schematic drawing of a system according to an exemplary embodiment.

FIG. 2 shows a table of exemplary patient data stored in a memory as shown in FIG. 1.

FIG. 3 shows a table of exemplary discharge criteria stored in the memory as shown in FIG. 1.

FIG. 4 shows a flow diagram of a method for evaluating a patient record according to an exemplary embodiment.

FIG. 5 shows an exemplary algorithm for a patient record evaluation according to the method of FIG. 4.

FIG. 6 shows a table of an exemplary output including results of a patient record evaluation according to the method of FIG. 4.

FIG. 7 shows a flow diagram of a method for evaluating discharge criteria according to another exemplary embodiment.

FIG. 8 shows a tree mapping discharge criteria to patient data according to the method of FIG. 7.

FIG. 9 shows an exemplary evaluations algorithm for the method of FIG. 7.

FIG. 10 shows a table of an exemplary output including results of a discharge criteria evaluation according to the method of FIG. 7.

FIG. 11 shows a flow diagram of a method for predicting a future patient record according to an exemplary embodiment.

FIG. 12 shows an exemplary predictive algorithm according to the method of FIG. 11.

FIG. 13 shows a table of an exemplary output including results of the predicting method according to FIG. 11.

FIG. 14 shows a flow diagram of a method for determining a recommendation regarding whether a patient is ready for discharge according to an exemplary embodiment.

FIG. 15 shows a flow diagram of a method for determining a recommendation regarding a patient's current treatment.

FIG. 16 shows a table of in-hospital treatment options according to the method of FIG. 15.

FIG. 17 shows a table of in and out-hospital treatment options according to the method of FIG. 15.

### DETAILED DESCRIPTION

The exemplary embodiments may be further understood with reference to the following description and the appended drawings wherein like elements are referred to with the same reference numerals. The exemplary embodiments relate to a system and method for predictive discharge planning for a patient that has been admitted to the hospital. In particular, the exemplary embodiments provide a system and method for generating recommendations regarding whether a patient should be discharged and whether a patient's current treatment plan should be modified. The system and methods of the exemplary embodiments may also predict other variable such as a patient's currently projected length of stay and the potential for a reduction, a risk-of-readmission index and total costs associated with the patient's care so that the patient's discharge may be planned and optimized by taking multiple factors into consideration. Although the exemplary embodiments are specifically described in regard to a patient having acute decompensated heart failure (ADHF), it will be understood by those of skill in the art that the system and method of the present invention may be used for patients having any of a variety of diseases or conditions such as renal dysfunction, COPD and other chronic conditions.

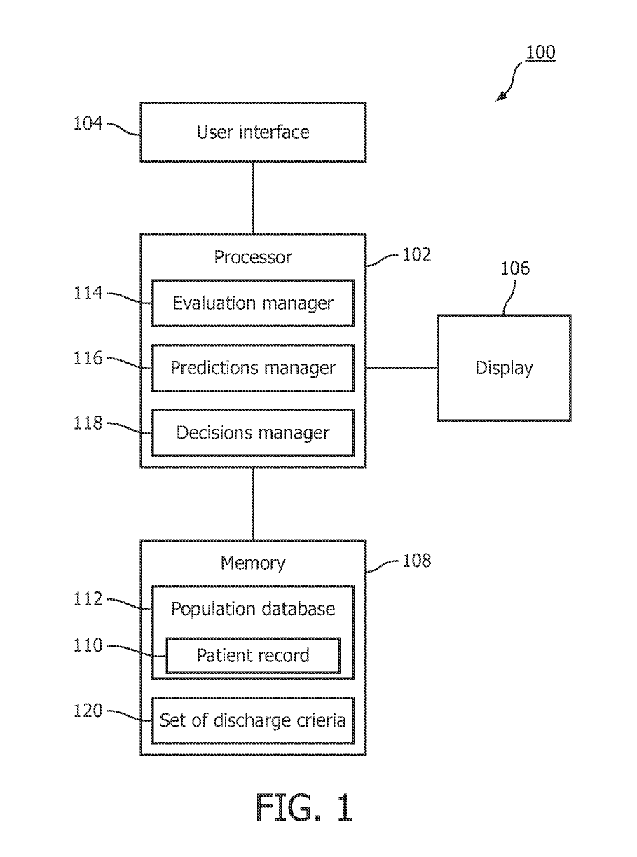

As shown in FIG. 1, a discharge planning system 100 according to an exemplary embodiment generates evaluations and recommendations regarding a patient's readiness for discharge, course of treatment and projections of the length of stay of the patient to facilitate patient discharge planning. The system 100 comprises a processor 102, a user interface 104, a display 106 and a memory 108. The memory 108 stores a population database 112 comprised of patient records for all current and previous patients, including a patient record 110 for a patient being analyzed. The memory 108 also stores a set of discharge criteria 120, which is used to determine the patient's readiness for discharge. The set of discharge criteria 120 may be specific to the patient's disease or condition or may also include general criteria that are applicable to most or all patients e.g., the post-discharge environment (home, assisted living facility, care providers, etc.). It will also be understood by those of skill in the art that the memory 108 may also includes additional information such as, for example, guidelines and treatment plans. The processor 102 is capable of running an evaluation manager program 114 for evaluating the patient record 110 and determining whether the discharge criteria 120 are satisfied, a predictions manager program 116 for predicting future results for the patient record 110 based on the population database 112 and a decisions manager program 118 for generating recommendations regarding 1) whether the patient is ready for discharge and/or 2) a treatment for the patient should be changed. The user inputs instructions selecting a desired program and/or task associated with the evaluations manager 114, predictions manager 116 or the decisions manager 118 via the user interface 104. The user also indicates preferences via the user interface 104, which may include input devices such as, for example, a keyboard, mouse and/or a touch display on the display 106. Evaluations, predictions and/or decision recommendations generated from the processed data are displayed on the display 106.

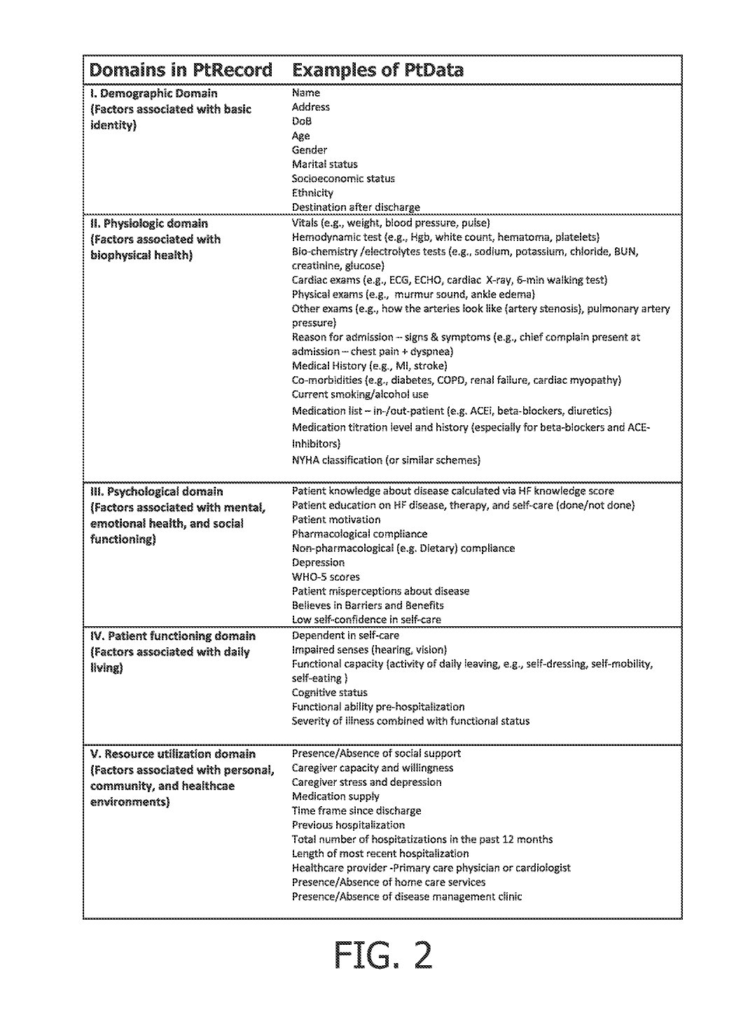

The patient record 110 includes patient data such as patient identification (e.g., name, age, gender), factors associated with biophysical health (e.g., reason for admission, vitals, test results, medical history and co-morbidities), factors associated with mental health, factors associated with daily living and factors associated with personal, community and healthcare environments. FIG. 2 shows a table of exemplary patient data that may be stored in the memory 108. The patient data may also include information such as treatments used and the patient's response to the treatments used. It will be understood by those of skill in the art that patient data may be stored to patient record 110 in the memory 108 as it is collected during the course of the patient's stay in the hospital. The population data 112 may include the types of patient data, as described above, for all current and previous patients. The patient data for previous patients stored in the population database 112 additionally includes information regarding the patient's length of stay in the hospital and readmission rates and statistics, as well as mortality and morbidity (if available). It will be understood by those of skill in the art that the patient record 110 represents patient data for a particular patient that is being assessed. Thus, any current patients in the population database 112 may be selected for the patient record 110.

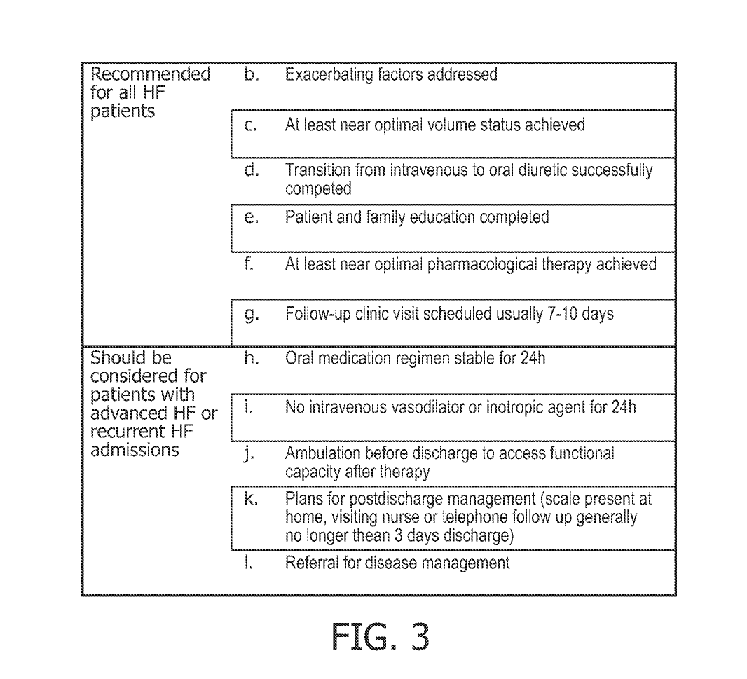

The set of discharge criteria 120 includes criteria that are used to assess whether a patient is ready for discharge. The discharge criteria may be specific to the patient's disease or condition. For example, the discharge criteria for a patient suffering from ADHF includes criteria such as whether exacerbating factors have been addressed, achievement of near-optimal pharmacological therapy (or at least successful initiation of pharmacological therapy and plan for up-titration), stability of oral medication regimen, etc. FIG. 3 shows a table including exemplary discharge criteria provided by the Heart Failure Society of America, which may be included in the set of discharge criteria 120 and stored in the memory 108. It will be understood by those of skill in the art, however, that the set of discharge criteria 120 may include any set of criteria accepted in the medical field. The set of discharge criteria 120 may also include any additional criteria deemed necessary or important by the user of the system 100. Alternatively, the set of discharge criteria 120 may be predetermined by the user. It will also be understood by those of skill in the art that the memory 108 may include multiple sets of discharge criteria 120, each set including criteria for a different disease/condition such that the system 100 may be utilized for any of a variety of different diseases and conditions.

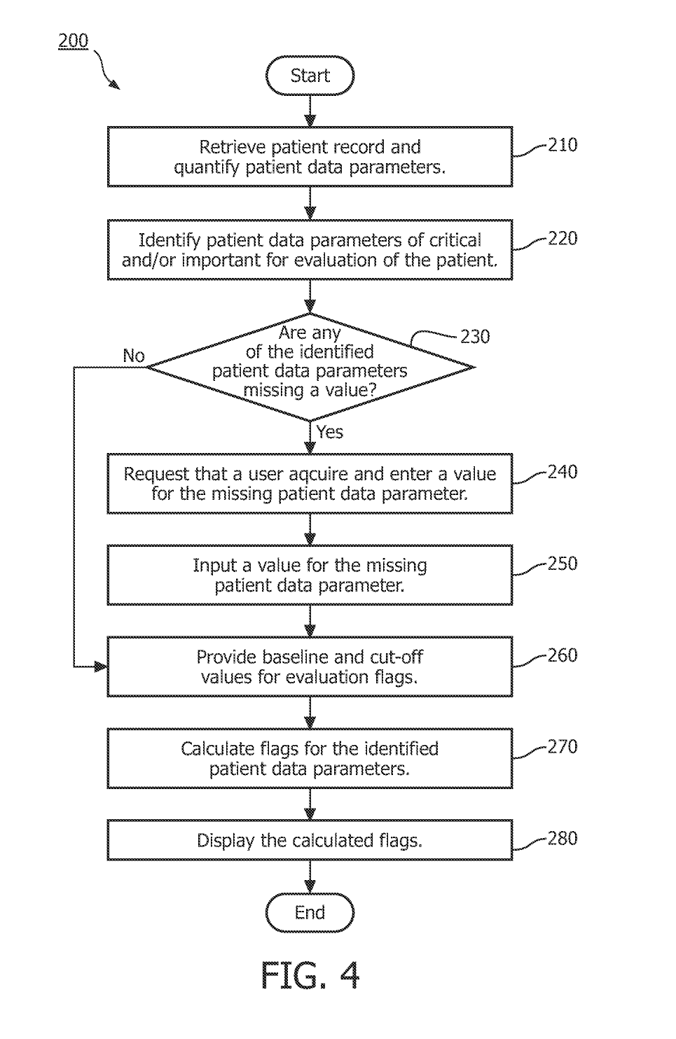

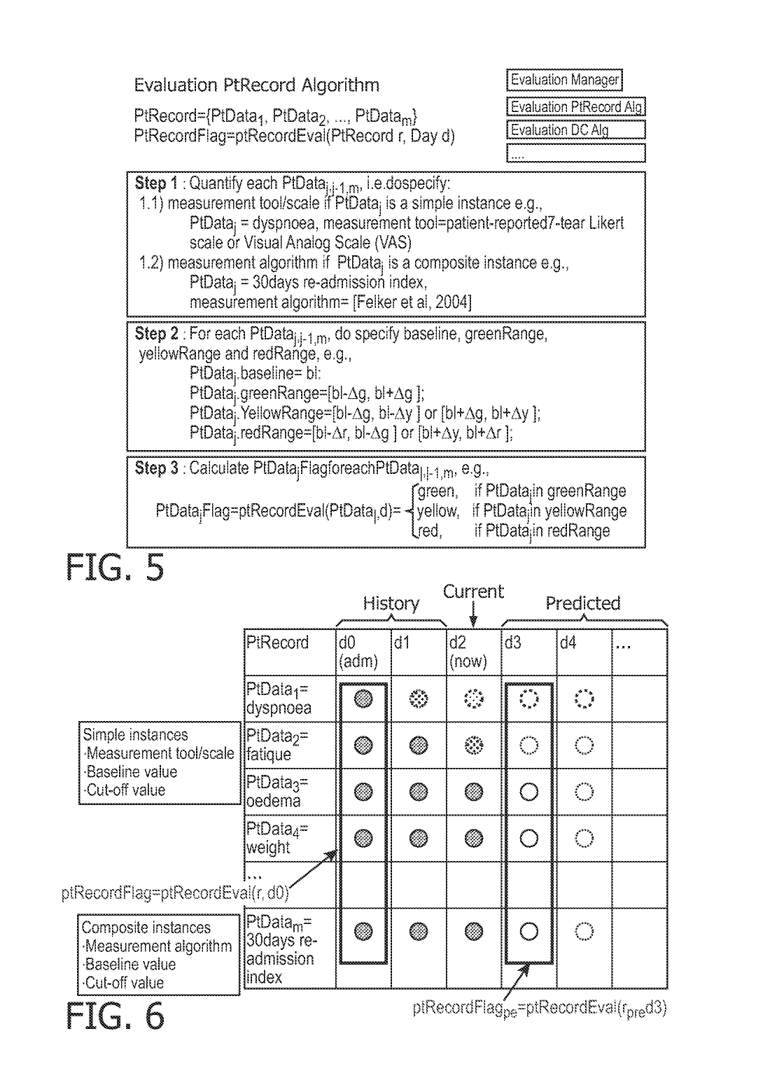

FIG. 4 shows a method 200 for evaluating the patient record 110 using the evaluation manager 114 according to an exemplary embodiment. In a step 210, the processor 102 runs the evaluation manager 114 to retrieve the patient record 110 from the memory 108 and quantify the patient data that have not yet been quantified by providing a measurement tool, scale or algorithm, as shown in FIG. 5. Some of the patient data (e.g., vitals, labs, meds) may already be quantified. However, some patient data such as specific symptoms may be recorded as “present” without quantification of severity. Further, patient data can be simple instances (e.g., weight, blood pressure, dyspnoea, edema, etc.) or composite instances (e.g., readmission index, mortality index, etc.). The latter can be calculated by risk stratification algorithms validated in various clinical studies. In a step 220, the processor 102 identifies patient data parameters that are critical or important for the evaluation of the patient (e.g., specific to the patient's disease or condition). As an alternative and optional method, the processor 102 identifies the critical or important patient data parameters prior to the quantification of the patient data parameters in the step 210 so that only the identified patient parameters are quantified. The processor 102 then determines whether any of the identified patient data parameters are missing a value, in a step 230. If any of the identified patient data parameters are missing a value, the evaluation manager 114 requests a user (e.g., nurse, cardiologist, etc.) to acquire and enter a value for the missing parameters, in a step 240. The user then enters the values for the missing data parameters in a step 250 via the user interface 104. Any entered values are used to update the patient record 110 stored in the memory 108.

If no identified patient data parameters are missing, the method 200 skips steps 240 and 250, moving directly to a step 260. In the step 260, baseline and cut-off values for evaluation flags are provided. The evaluation flags are used to determine whether each of the identified patient data parameters fall within a normal (e.g., clinically acceptable rather than a normal distribution), close-to-normal (e.g., borderline) or abnormal (e.g., clinically unacceptable) range. As shown in FIG. 5, the baseline and cut-off values define the ranges of each of the evaluation flags. The evaluation flags can be represented in various ways. As one non-limiting example, the evaluation flags are color-coded such that the normal range is represented by a green color, the close-to-normal range represented by a yellow color and the abnormal range represented by a red color. As another non-limiting example, graphs such as, for example, a pie chart, may be utilized to represent the evaluation flags. For example, a full pie-chart symbol may indicate that the patient data parameter is in the normal range, a half-full pie-chart may indicate that the patient data parameter is almost normal and an empty pie chart may indicate that the patient data parameter is abnormal or unacceptable. As another alternative, the evaluation categories are identified using descriptive terms such as “normal”, “close-to-normal” and “abnormal,” as described above. As yet a further alternative, the evaluation categories are identified using numerical values such that the numerical values fall within one of the ranges defined for each of the evaluation flags. It will be understood by those of skill in the art, however, that the evaluation flags may be identified and displayed using any of a variety of indicating methods and/or a combination of any of the indicating methods described above. The baseline and cut-off values may be predetermined ranges of values stored in the memory 108 or automatically calculated ranges using data from the population database 112. Alternatively, a user of the system 100 may input desired (e.g., patient-specific) baseline and cut-off values via the user interface 104.

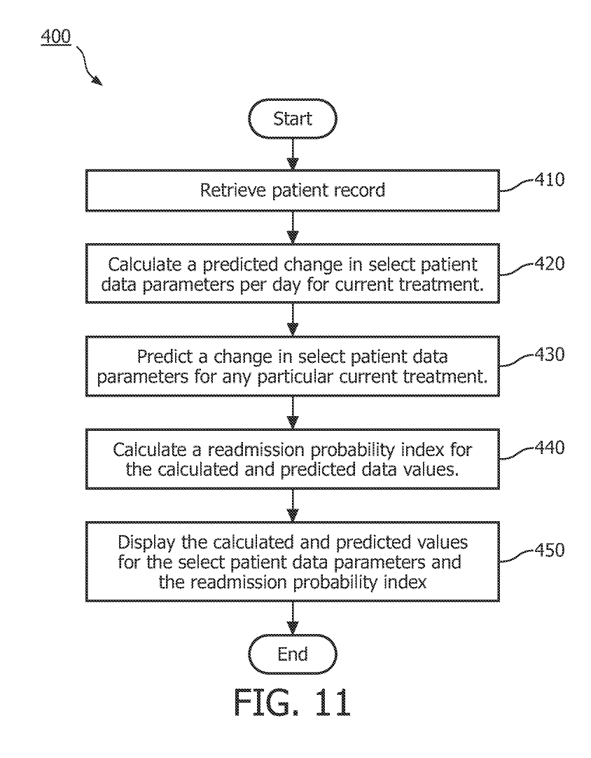

In a step 270, the evaluation manager 114 calculates a flag for each of the identified patient data parameters using the baseline and cut-off values provided in the step 260. The evaluation manager 114 determines whether values of each of the identified patient data parameters falls within the normal, close-to-normal or abnormal range on a given day. Since values of the identified parameters are available for current and previous days, flags are assigned for each of the available days. Flags may also be similarly predicted for future days based on predicted patient data, as will be further described below in regard to the method 400 described with reference to FIG. 11. The calculated and/or predicted flags are then displayed on the display 106 in a step 280, as shown in FIG. 6.

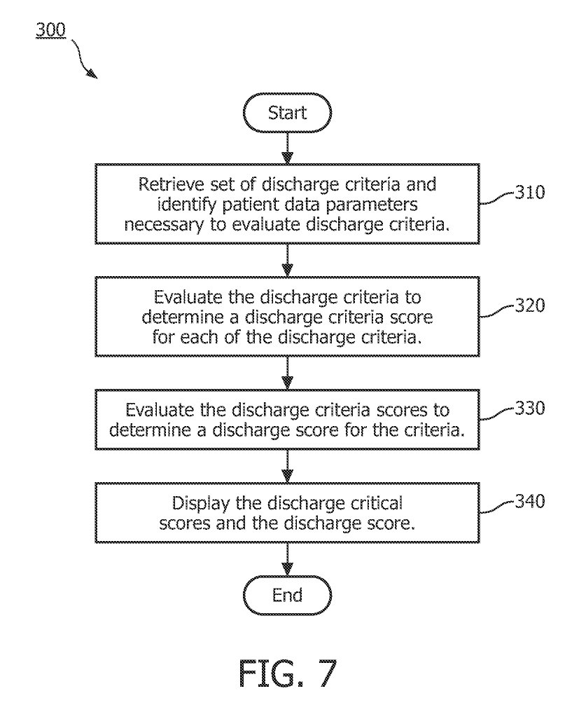

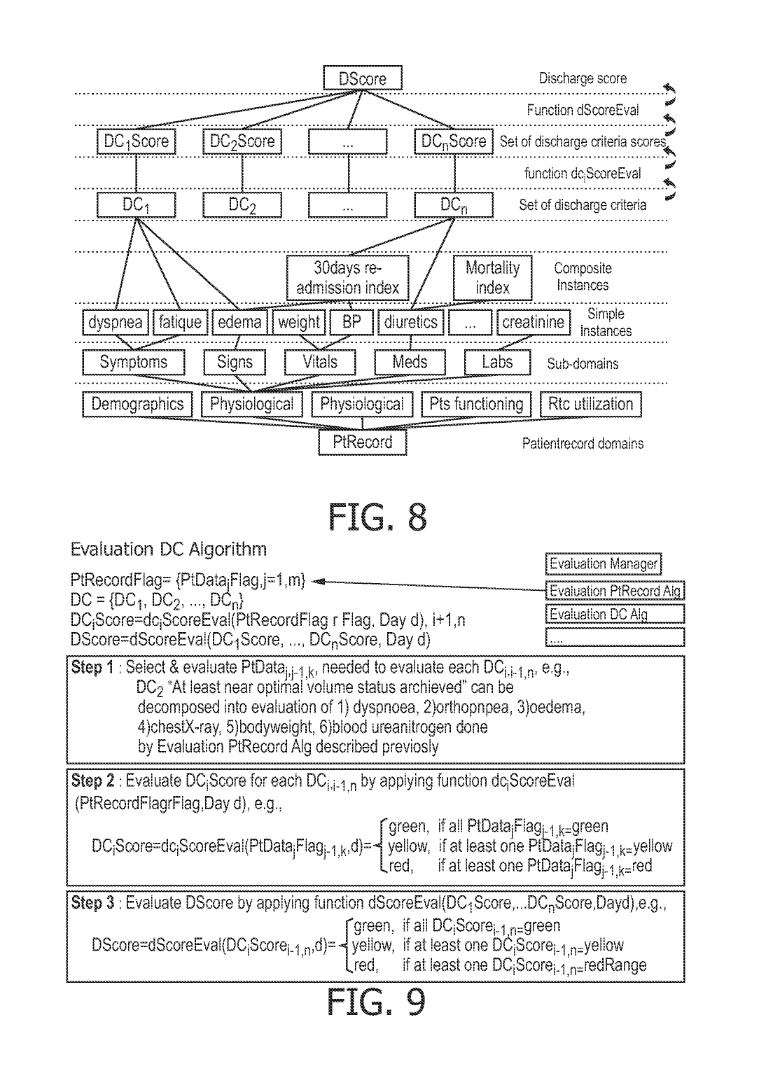

The evaluation manager 114 is also used to evaluate whether the patient record 110 satisfies the discharge criteria 120 according to a method 300, as shown in FIG. 7. The patient is given a discharge score for each of the discharge criteria 120 to determine the patient's readiness for discharge. The method 300 comprises accessing the discharge criteria 120 from the memory 108 and selecting corresponding patient data parameters necessary for determining satisfaction of the discharge criteria, in a step 310. The patient data parameters necessary for assessing each of the discharge criteria are manually selected by the user. Alternatively, the processor 102 automatically identifies the patient parameters using techniques such as, for example, machine learning or cluster analysis on the population database 112. An example of the selection process is shown in FIG. 8, as a mapping between the discharge criteria and either a simple or composite instance of patient data.

Once the necessary patient data has been identified, the evaluation manager 114, in a step 320, generates a discharge criteria score for each of the discharge criteria in the set of discharge criteria 120 on a given day using a discharge criteria evaluation algorithm. The discharge criteria evaluation algorithm evaluates the flag, as calculated in the step 270 using the method 200 described above, for each of the corresponding patient data parameters of the discharge criteria to determine the discharge criteria score. The discharge criteria score may indicate whether each of the discharge criteria is considered satisfied, somewhat satisfied or unsatisfied. Similarly to the evaluation flags described above in regard to the method 200, the satisfied discharge criteria may be represented by a green color (or a full pie-chart), the somewhat satisfied criteria may be represented by a yellow color (or a partially-filled pie chart) and the unsatisfied criteria may be represented by a red color (or an empty pie-chart). It will be understood by those of skill in the art that the discharge criteria may be displayed using other scoring methods besides the green, yellow and red color codes. For example, the scores may be represented using any predetermined color code, graphical representation, using descriptive terms such as “satisfied”, “somewhat satisfied” and “not satisfied,” numerical values, which may fall within defined ranges indicating a level of satisfaction, or any combination thereof. In an alternative embodiment, only the current value and the recent trend would be displayed using, for example, up, sideways and down arrows, instead of the history of scores.

The discharge criteria evaluation function may be defined as shown in FIG. 9. For example, the green discharge criteria score (e.g., satisfied) is defined as where all of the selected patient data parameters have a green flag (e.g., normal), the yellow score (e.g., somewhat satisfied) is defined as where at least one selected patient data parameter has a yellow flag (e.g., close to normal) and the red score (e.g., unsatisfied) is defined as where at least one selected patient data parameter has a red flag (e.g., abnormal). It will be understood by those of skill in the art, however, that the discharge criteria evaluation function may define each of the discharge criteria scores in any of a number of ways. The discharge criteria score definitions may be predefined for all patients. Alternatively, the user may define the discharge criteria scores for a particular patient.

In a step 330, the individual discharge criteria scores are used to generate a discharge score indicating whether the patient is ready to be discharged. The discharge score indicates a patient response to treatment and a level of readiness to be discharged. As shown in FIG. 9, the discharge score may be determined using a discharge score function. The discharge score function defines a green score (e.g., ready to be discharged) when all of the discharge criteria scores are green, yellow (e.g., close to discharge) when at least one discharge criteria score is yellow and red (e.g., not ready for discharge) when at least one discharge criteria score is red. It will be understood by those of skill in the art, however, that the discharge score function described above is exemplary only and may be defined to evaluate the discharge criteria scores in any of a variety of ways. Alternatively, the aggregate discharge score is calculated as a weighted average of the individual discharge criteria scores (e.g., before the discharge score is assigned a green, yellow or red flag) and evaluated against a separate set of thresholds. As yet a further alternative, the discharge score flag may be set to green if 90% of the discharge criteria scores are green and the remaining discharge criteria scores are not red, to yellow if 80% of the discharge criteria scores are green and nor more than one score is red, and to red for all remaining circumstances.

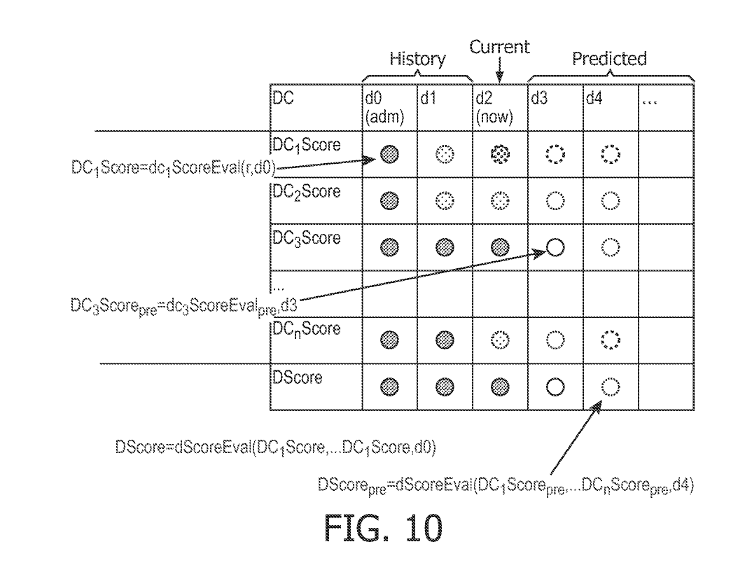

It will be understood by those of skill in the art that similarly to the discharge criteria scores, the discharge score may be indicated using any of a variety of display methods such as, for example, color codes, graphical representations, descriptive terms, numerical values falling within defined ranges of discharge readiness or any combination thereof. The discharge criteria scores generated in step 320 and the discharge score generated in step 330 for each of the previous and current days are displayed on the display 106, in a step 340, as shown in FIG. 10. Discharge criteria scores and the discharge score may also be similarly predicted for future dates by utilizing the predictions manager 116, as will be described in further detail below in regard to the method 400.

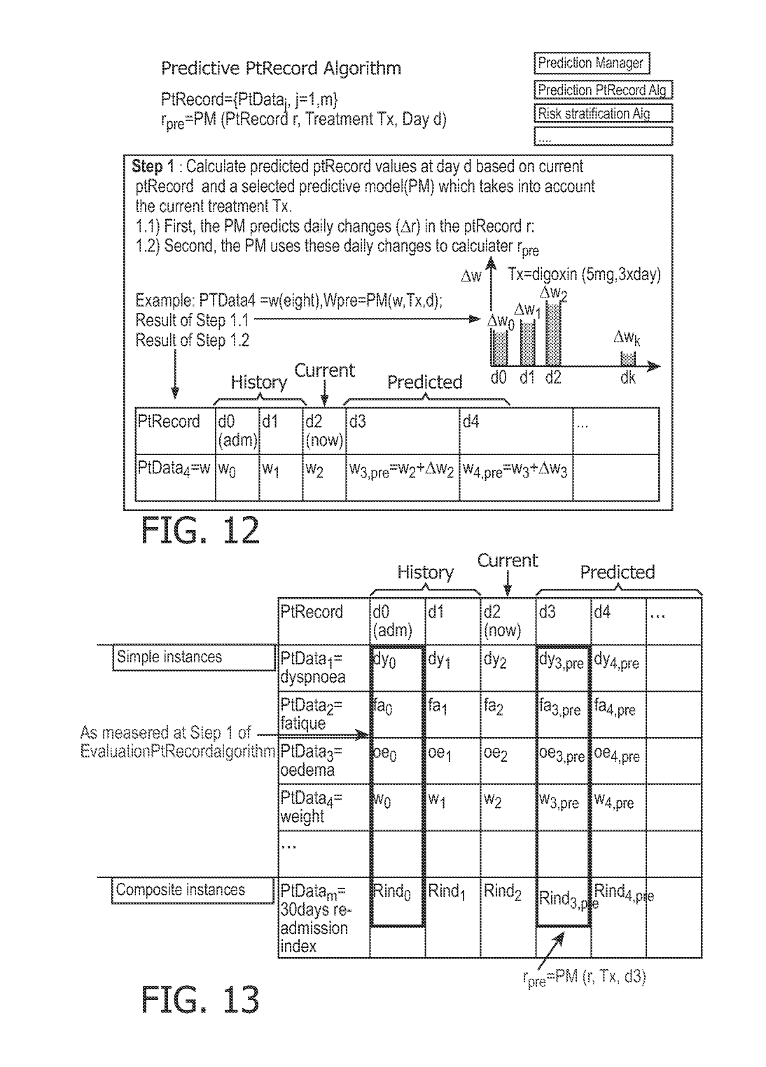

As shown in FIG. 11, a method 400 predicts patient data parameters using the predictions manager 116. The method 400 comprises retrieving the patient record 110, in a step 410. In a step 420, as shown in FIG. 12, the predictions manager 116 calculates a change in each relevant patient data parameter for past and current days, the change resulting from a current treatment utilized by the patient. The relevant patient data parameters may be, for example, the patient data parameters identified by the evaluations manager 114 in step 220 of the method 200 as critical and/or important for assessing the patient record 110. Alternatively, a user may select the patient data parameters for which the user would like a prediction.

In a step 430, the predictions manager 116 uses a prediction model, which considers both the calculated change under the current treatment along with treatment results stored in the population database 112 to predict future changes in each patient parameter for any particular treatment. Thus, the predictions for any particular treatment may be based on both the current treatment of the patient and other treatments based on treatment results from the population database 112. The predictions model is based on techniques for extracting patterns from the population database 112 such as, for example, multi-vector, machine learning or cluster analysis. The predictions model can also be extended to predict a readmission probability index along with a mortality probability index and/or the Charlson co-morbidity index for each of the calculated and predicted changes of the patient data parameter based on the population database 112, in a step 440. As shown in FIG. 13, the results of the calculated and predicted changes in patient data parameters along with the predicted readmission probability index are displayed on the display 106, in a step 450.

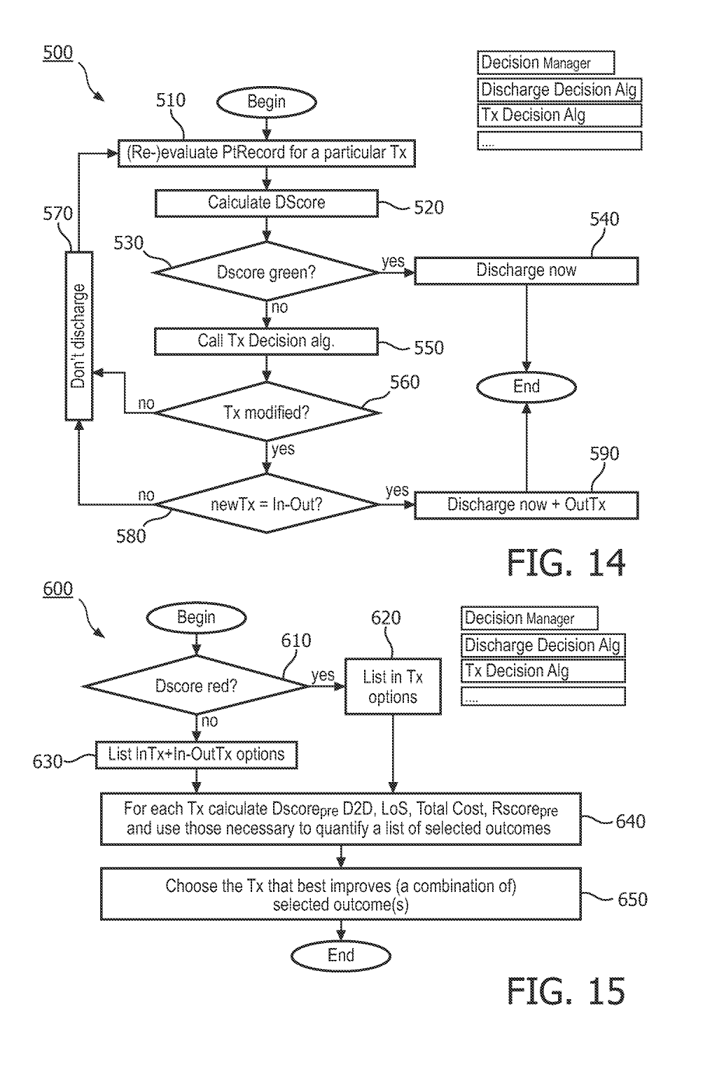

As shown in FIG. 14, a method 500 uses the decisions manager 118 to determine whether a patient is ready for discharge. The method 500 comprises evaluating the patient record 110 under the current treatment, in a step 510. The patient record 110 is evaluated using the evaluations manager 114, as described above in regard to the method 200. In a step 520, a discharge score is calculated for the current patient record 110 using, for example, the evaluations manager 114 to calculate the discharge score as described above in regard to the method 300. The processor 102 then determines whether the calculated discharge score is within a satisfactory range, in a step 530. As discussed above in regard to the method 300, the discharge score may be indicated using any of a variety of methods such as, for example, descriptive terms, color codes, graphical representations, numerical values within accepted predetermined ranges indicating a level of satisfaction or any combination thereof. Thus, a satisfactory discharge score may be indicated by, for example, a ‘green’ score, a “satisfied” score or a numerical value falling within a predetermined satisfactory range.

Where the current discharge score is determined to be satisfied, the method 500 proceeds to a step 540, in which the decisions manager 118 recommends that the patient be discharged. The recommendation may, for example, be displayed on the display 106 as “Ready to Discharge Now.” As will be understood by those of skill in the art, however, the readiness for discharge may be indicated to the user in any of a variety of ways so long as it clear to the user that the decisions manager 118 recommends that the patient be discharged, i.e., the patient has been stabilized under the current treatment. Where the current discharge score is not satisfactory in the step 530, the method 500 proceeds to a step 550, in which the decisions manager 118 evaluates whether modifications in the current treatment could potentially increase the patient's readiness for discharge. The treatment evaluation may be following a treatment evaluation method 600, as will be described in greater detail below in reference to FIG. 15.

In a step 560, the processor 102 determines whether a treatment modification has been made based on the treatment evaluation of step 550. If a treatment modification has not been made, the patient should remain in the hospital under the current treatment for further observation and evaluation. Thus, in a step 570, the decisions manager will recommend that the patient is not ready to be discharged. This discharge recommendation may be displayed on the display 106 as “Not Ready for Discharge.” As will be understood by those of skill in the art, however, the recommendation may be indicated in any of a variety of ways so long as it is clear to the user that the decisions manager 118 recommends that the patient not be discharged. If it is determined in the step 550 that a treatment modification has been made, the method 500 proceeds from the step 560 to a step 580, in which the processor 102 determines whether the modified treatment includes an out-patient component. Where the modified treatment is determined to include an out-patient component, the decisions manager 118 may recommend that the patient be discharged with the out-patient treatment, in a step 590. Where the modified treatment does not include an out-patient component, the method 500 reverts to the step 570, recommending that the patient not be discharged. It will be understood by those of skill in the art that where the decisions manager 118 does not recommend that the patient be discharged, the method 500 may revert back to the step 510 such that any new patient data will be re-evaluated to determine the patient's readiness for discharge.

As described above, if it is determined that the discharge score did not qualify for a recommendation of discharge (e.g., where the discharge score is not green), the method 500 may evaluate whether a treatment should be changed, using the method 600. As shown in FIG. 15, the method 600 determines whether the discharge score is in an unsatisfied category (e.g., red), in a step 610. If the discharge score is determined to be unsatisfied, the method proceeds to a step 620. If the discharge score is not in the unsatisfied category (e.g., “somewhat satisfied”, yellow), the method 600 proceeds to a step 630. In an alternate embodiment, rather than determining whether the discharge score is within the unsatisfied category in the step 610, the decision manager 118 may instead determine whether the discharge score is within the somewhat satisfied category. In this alternate embodiment, if it is determined that the discharge score is in the somewhat satisfied category, the method would proceed to the step 630. If it is determined that the discharge score is not in the somewhat satisfied category (e.g., where the discharge score is “unsatisfied” or red), the method 600 would proceed to the step 620.

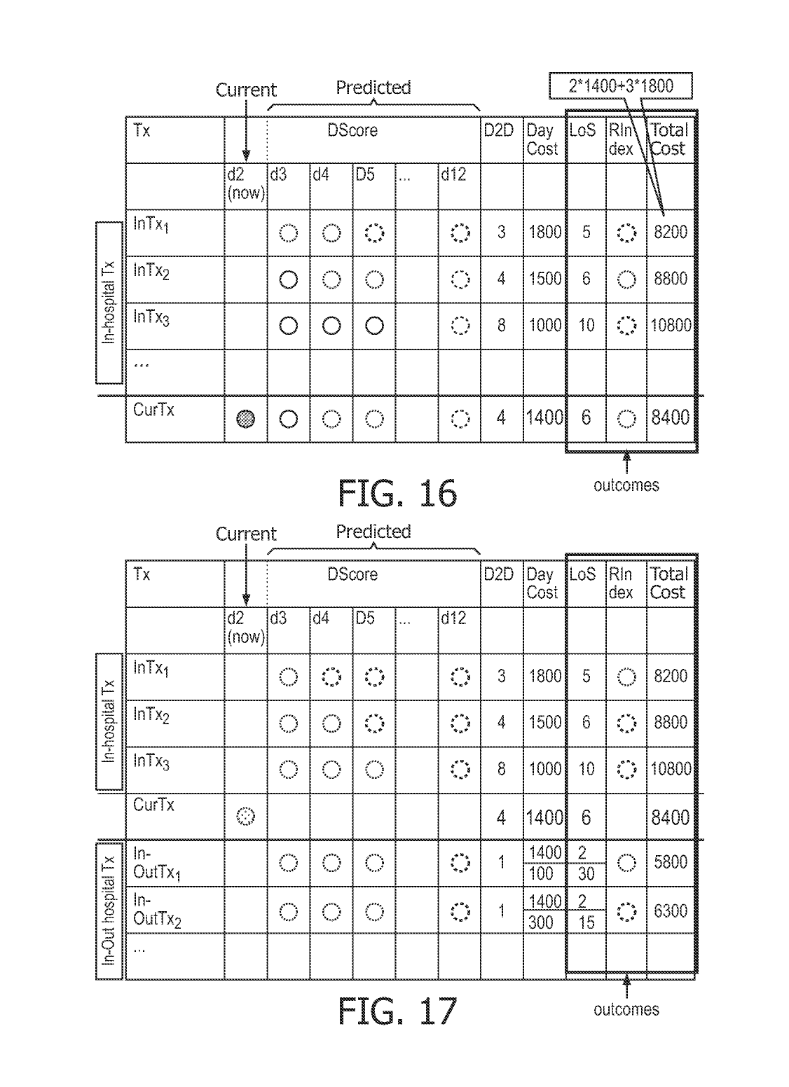

In the step 620, the decisions manager 118 generates a list of possible in-hospital treatment options, as shown in FIG. 16. In the step 630, the decisions manager 118 generates a list of possible in-hospital and out-hospital treatment options, as shown in FIG. 17. Both the step 620 and 630 proceed to the step 640, in which the discharge criteria is evaluated using the predicted patient record, as described in methods 300, 400, respectively, to calculate a predicted discharge score for the predicted patient data parameters for the treatments (Tx) listed in each of the steps 620, 630. The predicted discharge score (Dscoreₚᵣₑ) calculated in the step 640 is displayed with the lists shown in FIGS. 16 and 17.

Based on these predicted values a number of additional variables are also calculated. For example, the method 600 calculates variables such as predicted days until discharge (D2D), length of stay (LoS), readmission probability index (RIndex) and total medical cost (Total Cost), as shown in FIGS. 16 and 17. The variables may be calculated using, for example, the formulas:

D2D=(First Day DScoreₚᵣₑ=green)−(Current Day); 1)

Length-of-Stay (LoS)=Current Day+D2D; 2)

Readmission probability Index (Rlndex)=30-days post-discharge risk of re-admission calculated by the Predictions Manager; 3)

and

Total Medical Cost=ΣCost(Tx@Day dₖ), k=1, . . . , LoS. 4)

These variables are well-established outcomes that can be used to guide the treatment decisions, as described in a step 650. These variables also aid in hospital resource planning. For example, a predicted length of stay permits the hospital to predict bed availability, availability of physicians and nurses on the medical ward during day/night shifts, patients schedule of the discharge planner nurse who will prepare the patient for discharge, etc. These variables are also used to plan for out-of-hospital resources such as availability of out-patient services, telehealth services, long term condition care provided by a community nurse, palliative care, etc. Although the exemplary embodiment describes specific variable above, it will be understood by those of skill in the art that the method 600 may also include the prediction and/or calculation of other desired variables.

In the step 650, the decisions manager 118 generates a treatment recommendation that optimizes a selected outcome or a combination thereof. The decisions manager 118 may recommend a treatment based upon predetermined recommendation requirements such as, for example, guideline-conforming care, a minimum predicted length of stay, a minimum rate of readmission an/or a reduced total cost. The treatment decision recommendations may be, for example, to keep the current treatment (e.g., “Keep CurTx”), modify the current treatment to include an out-hospital treatment (e.g., “Consider Modifying CurTx into In-Out Tx₂”)or modify the current treatment to a different in-hospital treatment (e.g., “Consider Modifying CurTx into InTx₁”). It will be understood by those of skill in the art that these recommendations may be displayed on the display 106 as described above or in any of a variety of ways so long as the recommended treatment option is made clear to the user. The treatment decision recommendation may also include treatment adaptations actions that may be displayed as an alert to the user. The alerts may include, for example, suggestions for medication changes, new lab orders, scheduling follow-up visits, planning home visits, etc.

It is noted that the claims may include reference signs/numerals in accordance with PCT Rule 6.2(b). However, the present claims should not be considered to be limited to the exemplary embodiments corresponding to the reference signs/numerals.

Those skilled in the art will understand that the above-described exemplary embodiments may be implemented in any number of manners, including, as a separate software module, as a combination of hardware and software, etc. For example, the evaluation manager 114, the predictions manager 116 and the decisions manager 118 may be a program containing lines of code that, when compiled, may be executed on a processor.

It will be apparent to those skilled in the art that various modifications may be made to the disclosed exemplary embodiments and methods and alternatives without departing from the spirit or scope of the disclosure. Thus, it is intended that the present disclosure cover modifications and variations provided that they come within the scope of the appended claims and their equivalents.

1. A method of patient discharge planning, comprising:
evaluating, a processor, a patient record including patient data parameters of a patient;
determining, by the processor, a set criteria as a function of the patient data parameters; predicting, by the processor, a change in the patient record for all possible treatment options;
determining, by the processor, a discharge score as a function of the discharge criteria;
generating, by the processor, a discharge recommendation based on the discharge score; and
displaying, by a display the discharge recommendation to a user,
wherein the discharge recommendation includes one of (i) a first recommendation to discharge the patient if the discharge score exceeds a predetermined thereshold and (ii) a recommendation not to discharge the patient if the discharge score is below the predetermined threshold.

2. (canceled)

3. The method of claim 1, wherein evaluating the patient record includes:
identifying the patient data parameters of the patient record that are required for determining whether the patient is ready for discharge;
determining whether any of the identified patient data parameters are missing a value and requesting the missing value; and
quantifying values of the identified patient data parameters with respect to one of predetermined and patient-specific thresholds.

4. The method of claim 3, wherein evaluating the patient record further includes calculating a flag for the identified patient data parameters, the flag indicating whether a value of the patient data parameter is in a normal, close to normal or abnormal range.

5. (canceled)

6. The method of claim 1, wherein predicting the change in the patient record includes generating a list of possible treatment options including a current treatment, in-hospital and out-hospital treatment options.

7. The method of claim 1, further comprising:
generating a treatment recommendation indicating whether a current treatment of the patient should be modified.

8. The method of claim 6, wherein the predicted change is based on an evaluation of the current patient record under the current treatment and a population database including patient data for the in-hospital and out-hospital treatment options.

9. (canceled)

10. (canceled)

11. A system for discharge planning, comprising:
a memory storing a patient record including patient data parameters for a patient and a population database including patient data for all patients;
a processor configured to: (a) evaluate the patient record, (b) determine a set of discharge criteria as a function of the patient data parameters, (c) predict a change in the patient record, (d) determine a discharge score as a function of the discharge criteria, and (c) generate a discharge recommendation based on the discharge score;
a display displaying the discharge recommendation,
wherein the discharge recommendation includes one of (i) a first recommendation to discharge the patient if the discharge score exceeds a predetermined threshold and (ii) a recommendation not to discharge the patient if the discharge score is below the predetermined threshold.

12. (canceled)

13. The system of claim 11, wherein the processor identifies the patient data parameters of the patient record that are required for determining whether the patient is ready for discharge, determines whether any of the identifies patient data parameters are missing a value, requests the missing value and quantifies values of the identified patient data parameters.

14. The system of claim 14, further comprising:
a user interface for entering an input for any identified patient data parameters that are missing a value.

15. The system of claim 14, wherein the processor calculates a flag for the identified patient data parameters, the flag indicating whether a value of the patient data parameter is in a normal, close to normal or abnormal range.

16. The system of claim 11, wherein the processor generates a list of possible treatment options including a current treatment, in-hospital and out-hospital treatment options so that the predicted change is based on an evaluation of the current patient record under the current treatment and a population database including patient data for the in-hospital and out-hospital treatment options.

17. The system of claim 11, wherein the processor generates a treatment recommendation indicating whether a current treatment of the patient should be modified.

18. The system of claim 11, wherein the processor determines whether a current treatment has been modified and generates the discharge recommendation based on whether the current treatment has been modified.

19. The system of claim 11, wherein the processor predicts at least one of a discharge score for the predicted change in the patient record, days until discharge for the patient, a length of stay, a readmission probability index and a total medical cost with respect to the patient based on the predicted change in the patient record (110).

20. A computer-readable storage medium including a set of instructions executable by a processor, the set of instructions operable to:
evaluate a patient record including patient data parameters of a patient;
determine a set of discharge criteria as a function of the patient data parameters;
predict a change in the patient record for all possible treatment options;
determine a discharge score as a function of the discharge criteria;
generate a discharge recommendation indicating whether the patient is ready for discharge based on the discharge score; and
display the discharge recommendation to a user.
